(19) United States
(12) Patent Application Publication
(10) Pub. No.: US 2022/0017082 A1
(43) Pub. Date: Jan. 20, 2022

(54) TRAVEL CONTROL SYSTEM FOR VEHICLE

(71) Applicant: Mazda Motor Corporation, Hiroshima (JP)

(72) Inventors: Shinsuke SAKASHITA, Aki-gun (JP); Daisuke HORIGOME, Aki-gun (JP); Masato ISHIBASHI, Aki-gun (JP); Eiichi HOJIN, Aki-gun (JP)

(73) Assignee: Mazda Motor Corporation, Hiroshima (JP)

(21) Appl. No.: 17/486,950

(22) Filed: Sep. 28, 2021

Related U.S. Application Data
(63) Continuation of application No. PCT/JP2020/009818, filed on Mar. 6, 2020.

(30) Foreign Application Priority Data
Mar. 29, 2019 (JP) 2019-068435

(51) Int. Cl. B60W 30/09; B60W 30/14; B60W 50/00; B60W 50/14

(52) U.S. Cl. CPC B60W 30/09; B60W 30/14; B60W 50/0098; B60W 2420/52; B60W 2050/0028; B60W 2420/42; B60W 50/14

(57) ABSTRACT

A motor vehicle cruise control system includes: an arithmetic unit configured to calculate a physical momentum of a traveling device for achieving a target motion of a motor vehicle that is traveling along a traveling route generated, based on an output from a vehicle exterior information acquisition device; and a device controller configured to generate, and output, an actuation control signal for the traveling device in the motor vehicle, based on an arithmetic result obtained by the arithmetic unit. Driving operation information on an operation performed by a driver is input to both the arithmetic unit and the device controller in parallel. The arithmetic unit is configured to reflect the driving operation information in a process of determining the target motion. The device controller is configured to reflect the driving operation information in the control of the actuation of the traveling device.

### CROSS-REFERENCE TO RELATED APPLICATIONS

The present application is based on PCT filing PCT/JP2020/009818, filed Mar. 6, 2020, which claims priority to Japanese Patent Application 2019-068435, filed Mar. 29, 2019, the entire contents of each are incorporated herein by reference.

### BACKGROUND

### Field

The present disclosure belongs to a technical field related to a motor vehicle cruise control system.

### Description of the Related Art

There has been a known control system which controls a plurality of on-board devices for traveling, which are mounted in a motor vehicle.

For example, Patent Document 1 discloses, as a vehicle cruise control system, a control system including unit controllers respectively controlling the on-board units, a domain controller controlling the unit controllers as a whole, and an integrated controller controlling the domain controllers as a whole. The control system is divided into a plurality of domains respectively corresponding to the functions of the on-board units in advance. Each of the domains is stratified into a group of the unit controllers and the domain controller. The integrated controller dominates the domain controllers.

In Patent Document 1, the unit controllers each calculate a controlled variable of an associated one of the on-board units, and each output a control signal for achieving the controlled variable to the associated on-board unit.

### CITATION LIST

### Patent Document

Patent Document 1: Japanese Unexamined Patent Publication No. 2017-61278

### Non-Patent Document

Non-Patent Document 1: Society of Automotive Engineers of Japan, Inc., “Taxonomy and Definitions for Terms Related to Driving Automation Systems for On-road Motor Vehicles,” Feb. 1, 2018, p.19

### SUMMARY

### Technical Problems

In recent years, development of driving automation systems for motor vehicles has been promoted nationally. The driving automation system has driver assistance and driving automation functions. The driving automation function is further classified into levels of “partial driving automation,” “conditional driving automation,” “high driving automation,” and “full driving automation” (Non-patent Document 1).

In this case, if driving of a motor vehicle is to be automated, the level of automation may be fixed at any one of the foregoing levels. Alternatively, the level of automation may be changed based on an environmental change inside and outside the motor vehicle, a change in the condition of the motor vehicle, driver's needs, and other elements, i.e., in response to an associated driving situation. Then, for example, while the driver is driving the motor vehicle with “driver assistance,” the driving may be changed to automated driving, such as “partial driving automation” or “conditional driving automation.” In such a case, if the driving automation level for the motor vehicle is changed at a time unexpected by the driver, the driver may feel uncomfortable.

Further, depending on the driving situation, the driver is likely to want to reflect his/her intention in driving while autonomous driving is performed. For example, during autonomous driving, the driver is likely to want to slightly reduce the speed of the motor vehicle to see the scenery or to check ambient conditions, or is likely to unexpectedly want to drop by a facility that has come into sight or any other place. For example, at the driving automation level 3, the driver is highly likely to be seated so as to be able to drive the motor vehicle to address a situation where autonomous driving is difficult to continue. If the driver's needs described above arise, the driver is likely to try to operate the steering wheel, brake, or any other component. If, in such a case, a driver's operation is not reflected in a motion of the motor vehicle, this situation is inconvenient for the driver.

The present disclosure was made in view of the problems. It is an object of the present disclosure to provide a motor vehicle cruise control system that achieves control reflecting a driver's intention without impairing the driver's comfort even if the motor vehicle intervenes in driving (e.g., if driver assistance or driving automation is provided).

### Solutions to the Problems

To solve the foregoing problems, the present disclosure is directed to a motor vehicle cruise control system for controlling traveling of a motor vehicle. The system includes: arithmetic circuitry configured to generate a route that avoids an obstacle on a road, based on an output from a vehicle exterior information acquisition device, determine a target motion of the motor vehicle during traveling of the motor vehicle along the route, and calculate a target physical momentum of a traveling device for achieving the target motion, the vehicle exterior information acquisition device being configured to acquire information on an environment outside of the motor vehicle. The system also includes device control circuitry configured to generate an actuation control signal for controlling an actuation of the traveling device mounted in the motor vehicle, based on an arithmetic result obtained by the arithmetic circuitry, and output the actuation control signal to the traveling device. Driving operation information on an operation performed by a driver is input to both the arithmetic circuitry and the device control circuitry in parallel. The arithmetic circuitry is configured to reflect the driving operation information in a process of determining the target motion. The device control circuitry is configured to reflect the driving operation information in the control of the actuation of the traveling device.

Note that “traveling devices” as used herein indicates devices such as actuators and sensors to be controlled while the motor vehicle is travelling (for example, one or more active devices that control a motion of a vehicle).

According to this configuration, the driving operation information on the operation performed by the driver is input to both the arithmetic unit (arithmetic circuitry) and the device controller (device circuitry) in parallel. Thus, in the arithmetic unit, the driving operation information is reflected in the calculation of the target physical momentum. This can prevent the driver from feeling uncomfortable about the timing and degree of driver assistance intervention. Furthermore, the device controller is configured to reflect the driving operation information in the control of the actuation of the traveling device. This allows the output of the arithmetic unit to be reviewed, and allows switching to be made from autonomous driving to manual driving.

In the motor vehicle cruise control system, the device controller generates a manual driving signal for controlling the actuation of the traveling device, based on the driving operation information on the operation performed by the driver, and outputs the manual driving signal, instead of the actuation control signal, to the traveling device if a predetermined condition determined in advance is satisfied.

According to this configuration, the motor vehicle cruise control system configured to enable autonomous driving can reliably control driving in accordance with the driver's driving operation. In other words, the motor vehicle cruise control system configured to enable autonomous driving can function to disable autonomous driving.

In the motor vehicle cruise control system, the device controller generates manual driving information for controlling the actuation of the traveling device, based on the driving operation information on the operation performed by the driver, and corrects the actuation control signal based on the driving operation information if a behavior of the traveling device based on the actuation control signal deviates from a motion based on the manual driving information by an amount greater than or equal to a predetermined reference.

According to this configuration, for example, if the target physical momentum which is calculated by the arithmetic unit and which is produced on the traveling device deviates from a motion resulting from driving control based on the driving operation information on the driver' s operation by an amount greater than or equal to the predetermined reference, correcting the actuation control signal based on the driving operation information can provide control that reflects the driver's intention without impairing the driver's comfort.

### Advantages

As can be seen from the foregoing description, according to the present disclosure, a motor vehicle cruise control system can achieve control that reflects a driver's intention without impairing the driver's comfort even if the motor vehicle intervenes in driving (e.g., even if driver assistance or driving automation is provided).

### BRIEF DESCRIPTION OF THE DRAWINGS

FIG. 1 schematically shows a configuration of a vehicle which is controlled by a vehicle cruise control system according to an exemplary embodiment.

FIG. 2 is a schematic view illustrating a configuration of an engine.

FIG. 3 is a schematic view showing a vehicle equipped with an arithmetic unit. FIG. 4 is a block diagram showing a control system of a motor vehicle according to a first embodiment.

FIG. 5 is a block diagram showing the relationship between abnormality detectors and device controllers.

FIG. 6 shows an example of a route along which the vehicle travels.

FIG. 7 is a block diagram showing a control system of a motor vehicle according to a second embodiment.

FIG. 8 is a diagram of a computer structure that implements the various circuitry (programable and discrete) in the computation device according to the various embodiments.

FIG. 9 is a diagram of an AI-based computer architecture according to an embodiment.

FIG. 10 is an example diagram of an image used for training a model to detect distance to an obstacle and a protection zone around the obstacle.

FIG. 11 is a diagram of a data extraction network according to an embodiment.

FIG. 12 is a diagram of a data analysis network according to an embodiment.

FIG. 13 is a diagram of a concatenated source feature map.

### DESCRIPTION OF EMBODIMENTS

An exemplary embodiment will now be described in detail with reference to the drawings. Note that “traveling devices,” which will be described below in the present embodiment, indicate devices such as actuators and sensors to be controlled while a vehicle 1 is traveling. Although described in detail below, examples of the “traveling devices” include devices related to traveling of the vehicle, such as a combustion injection valve, a spark plug, and a brake actuator.

(First Embodiment)

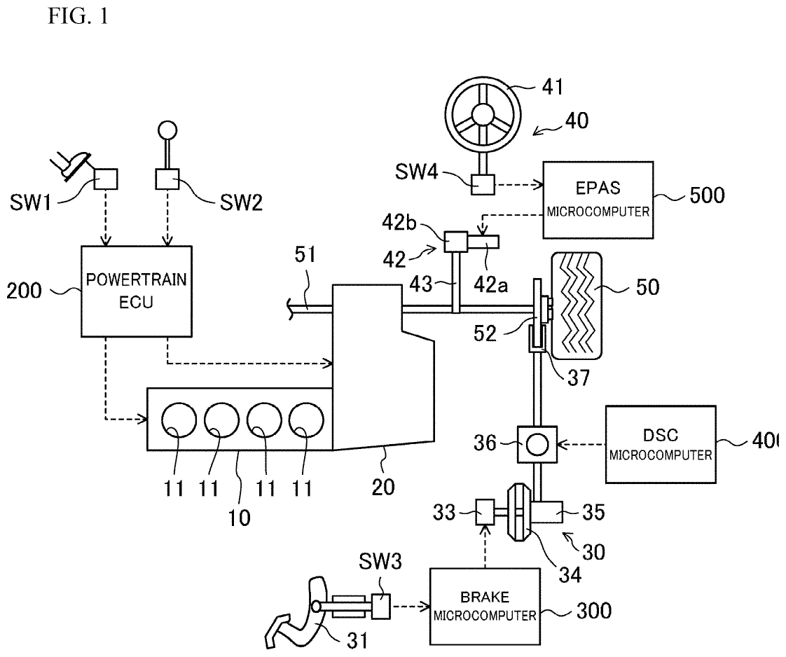

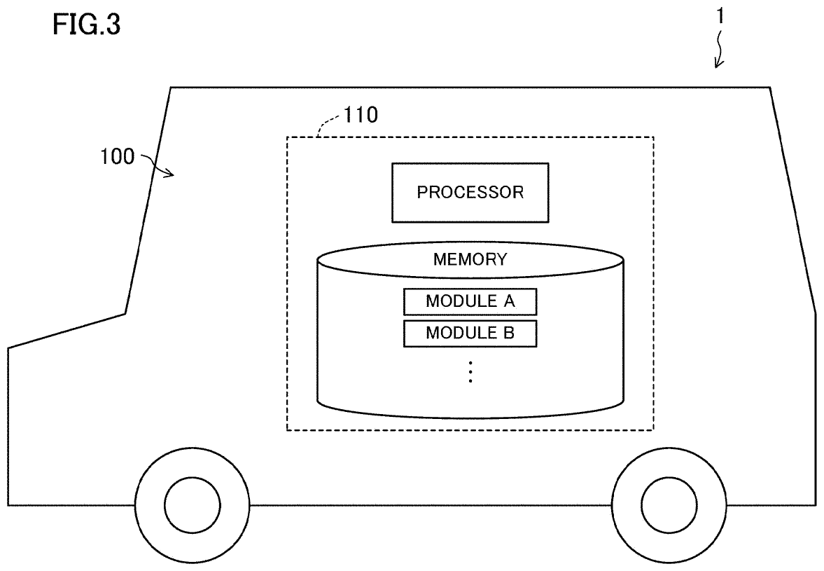

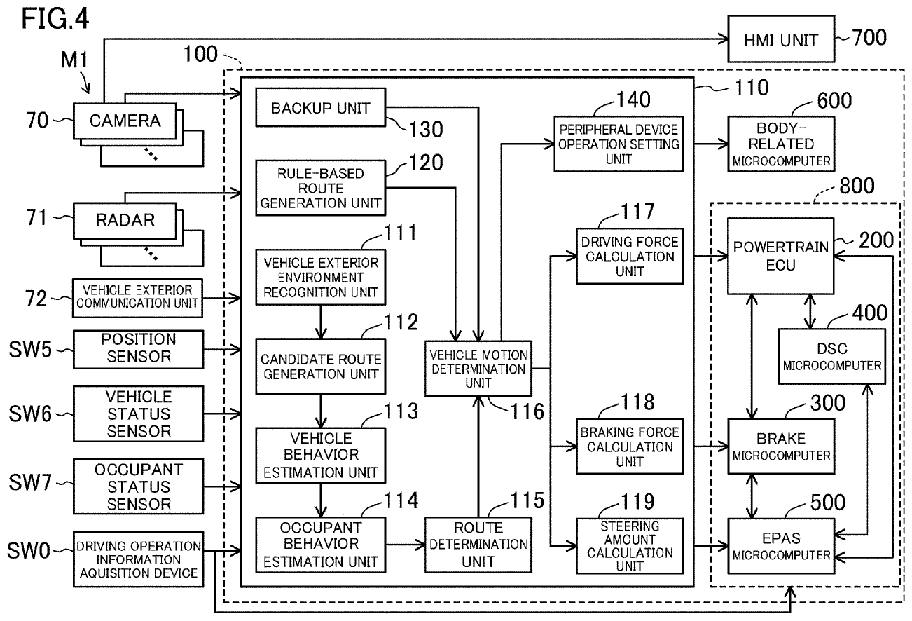

FIG. 1 schematically shows a configuration of a vehicle 1 (see FIG. 3) which is controlled by a cruise control system according to the present embodiment. The vehicle 1 is a motor vehicle that allows manual driving in which the vehicle 1 runs in accordance with an operation of an accelerator and any other component by a driver, assist driving in which the vehicle 1 runs while assisting the operation by the driver, and autonomous driving in which the vehicle 1 runs without the operation by the driver.

The vehicle 1 includes an engine 10 as a drive source having a plurality of (four, for example, in the present embodiment) cylinders 11, a transmission 20 coupled to the engine 10, a brake device 30 that brakes rotation of front wheels 50 serving as driving wheels, and a steering device 40 that steers the front wheels 50 serving as steered wheels.

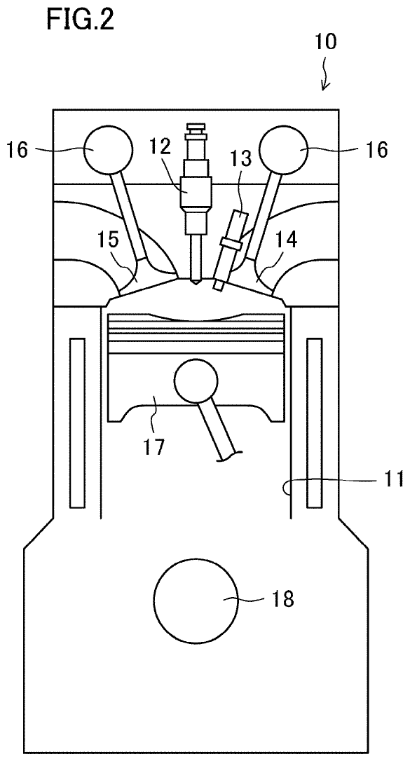

The engine 10 is, for example, a gasoline engine. As shown in FIG. 2, each cylinder 11 of the engine 10 includes an injector 12 configured to supply fuel into the cylinder 11 and a spark plug 13 for igniting an air-fuel mixture of the fuel and intake air supplied into the cylinder 11. In addition, the engine 10 includes, for each cylinder 11, an intake valve 14, an exhaust valve 15, and a valve train mechanism 16 that adjusts opening and closing operations of the intake valve 14 and the exhaust valve 15. In addition, the engine 10 is provided with pistons 17 each configured to reciprocate in the corresponding cylinder 11 and a crankshaft 18 connected to the pistons 17 via connecting rods. Note that the engine 10 may be a diesel engine. In a case of adopting a diesel engine as the engine 10, the spark plug 13 does not have to be provided. The injector 12, the spark plug 13, and the valve train mechanism 16 are examples of devices related to a powertrain.

The transmission 20 is, for example, a stepped automatic transmission. The transmission 20 is arranged on one side of the engine 10 along the cylinder bank. The transmission 20 includes an input shaft coupled to the crankshaft 18 of the engine 10, and an output shaft coupled to the input shaft via a plurality of reduction gears. The output shaft is connected to an axle 51 of the front wheels 50. The rotation of the crankshaft 18 is changed by the transmission 20 and transmitted to the front wheels 50. The transmission 20 is an example of the devices related to the powertrain.

The engine 10 and the transmission 20 are powertrain devices that generate a driving force for causing the vehicle 1 to travel. The operations of the engine 10 and the transmission 20 are controlled by a powertrain electric control unit (ECU) 200, which includes programable circuitry to execute power train related calculations and output control signals that control an operation of the power train. As used herein, the term “circuitry” may be one or more circuits that optionally include programmable circuitry. For example, during the manual driving of the vehicle 1, the powertrain ECU 200 controls an injection amount from and a timing for fuel injection by the injector 12, a timing for ignition by the spark plug 13, timings for opening the intake and exhaust valves 14 and 15 by the valve train mechanism 16, and the duration of opening these valves, based on values such as a detected value of an accelerator position sensor SW1 that detects an accelerator position and any other sensor, which correspond to an operation amount of the accelerator pedal by the driver. In addition, during the manual driving of the vehicle 1, the powertrain ECU 200 adjusts the gear position of the transmission 20 based on a preferred driving force calculated from a detection result of a shift sensor SW2 that detects an operation of the shift lever by the driver and the accelerator position. In addition, during the assist driving or the autonomous driving of the vehicle 1, the powertrain ECU 200 basically calculates a controlled variable for each traveling device (injector 12 and any other component in this case) and outputs a control signal to the corresponding traveling device, so as to achieve a target driving force calculated by an arithmetic unit 110 described hereinafter. The powertrain ECU 200 is an example of a device controller, or device control circuitry.

The brake device 30 includes a brake pedal 31, a brake actuator 33, a booster 34 connected to the brake actuator 33, a master cylinder 35 connected to the booster 34, dynamic stability control (DSC) devices 36 (or DSC circuitry) that adjust the braking force, and brake pads 37 that actually brake the rotation of the front wheels 50. To the axle 51 of the front wheels 50, disc rotors 52 are provided. The brake device 30 is an electric brake, and actuates the brake actuator 33 in accordance with the operation amount of the brake pedal 31 detected by the brake sensor SW3, to actuate the brake pads 37 via the booster 34 and the master cylinder 35. The brake device 30 clamps the disc rotor 52 by the brake pads 37, to brake the rotation of each front wheel 50 by the frictional force generated between the brake pads 37 and the disc rotor 52. The brake actuator 33 and the DSC device 36 are examples of devices related to the brake.

The actuation of the brake device 30 is controlled by a brake microcomputer 300 (also referred to as brake control circuitry, for example) and a DSC microcomputer 400 (also referred to as DSC circuitry, for example). For example, during the manual driving of the vehicle 1, the brake microcomputer 300 controls the operation amount of the brake actuator 33 based on a detected value from the brake sensor SW3 that detects the operation amount of the brake pedal 31 by the driver, and any other sensor. In addition, the DSC microcomputer 400 controls actuation of the DSC device 36 to add a braking force to the front wheels 50, irrespective of an operation of the brake pedal 31 by the driver. In addition, during the assist driving or the autonomous driving of the vehicle 1, the brake microcomputer 300 basically calculates a controlled variable for each traveling device (brake actuator 33 in this case) and outputs a control signal to the corresponding traveling device, so as to achieve a target braking force calculated by the arithmetic unit 110 described hereinafter. The brake microcomputer 300 and the DSC microcomputer 400 are an example of the device controller. Note that the brake microcomputer 300 and the DSC microcomputer 400 may be configured by a single microcomputer.

The steering device 40 includes a steering wheel 41 to be operated by the driver, an electronic power assist steering (EPAS) device 42 (or EPAS circuitry, such as a microcomputer) configured to assist the driver in a steering operation, and a pinion shaft 43 coupled to the EPAS device 42. The EPAS device 42 includes an electric motor 42a, and a deceleration device 42b configured to reduce the driving force from the electric motor 42a and transmit the force to the pinion shaft 43. The steering device 40 is a steering system of a steer-by-wire type, and actuates the EPAS device 42 in accordance with the operation amount of the steering wheel 41 detected by a steering angle sensor SW4, so as to rotate the pinion shaft 43, thereby controlling the front wheels 50. The pinion shaft 43 is coupled to the front wheels 50 through a rack bar, and the rotation of the pinion shaft 43 is transmitted to the front wheels via the rack bar. The EPAS device 42 is an example of a steering related device.

The actuation of the steering device 40 is controlled by an EPAS microcomputer 500. For example, during the manual driving of the vehicle 1, the EPAS microcomputer 500 controls the operation amount of the electric motor 42a based on a detected value from the steering angle sensor SW4 and any other sensor. In addition, during the assist driving or the autonomous driving of the vehicle 1, the EPAS microcomputer 500 basically calculates a controlled variable for each traveling device (EPAS device 42 in this case) and outputs a control signal to the corresponding traveling device, so as to achieve a target steering amount calculated by the arithmetic unit 110 described hereinafter. The EPAS microcomputer 500 is an example of a device controller.

Although will be described later in detail, in the present embodiment, the powertrain ECU 200, the brake microcomputer 300, the DSC microcomputer 400, and the EPAS microcomputer 500 are configured to be capable of communicating with one another. In the following description, the powertrain ECU 200, the brake microcomputer 300, the DSC microcomputer 400, and the EPAS microcomputer 500 may be simply referred to as the device controller, or device control circuitry.

As will be described in detail below, the arithmetic unit 110 may include a vehicle external environment recognition unit 111 (as further described in U.S. application Ser. No. 17/120,292 filed Dec. 14, 2020, and U.S. application Ser. No. 17/160,426 filed Jan. 28, 2021, the entire contents of each of which being incorporated herein by reference), an occupant behavior estimation unit 114 (as further described in U.S. application Ser. No. 17/103,990 filed Nov. 25, 2020, the entire contents of which being incorporated herein by reference), a route generation unit 120 (as further described in more detail in U.S. application Ser. No. 17/161,691, filed 29 Jan. 2021, U.S. application Ser. No. 17/161,686, filed 29 Jan. 2021, and U.S. application Ser. No. 17/161,683, the entire contents of each of which being incorporated herein by reference), a vehicle motion determination unit 116 and a route determination unit 115 (as further described in more detail in U.S. application Ser. No. 17/159,178, filed Jan. 27, 2021, the entire contents of which being incorporated herein by reference), a six degrees of freedom (6DoF) model of the vehicle (as further described in more detail in U.S. application Ser. No. 17/159,175, filed Jan. 27, 2021, the entire contents of which being incorporated herein by reference), a braking force calculation unit 118 and a steering angle calculation unit 119 (as further described in more detail in U.S. application Ser. No. 17/159,178, supra) a driving force calculation unit 117 (as further described in more detail in U.S. application Ser. No. 17/159,178, supra), a candidate route generation unit 112 (as further described in more detail in U.S. application Ser. No. 17/159,178, supra), a vehicle external environment recognition unit 111 (as further described in PCT application WO2020184297A1 filed Mar. 3, 2020, the entire contents of which being incorporated herein by reference), an occupant behavior estimation unit 114 (as further described in U.S. application Ser. No. 17/160,426 filed Jan. 28, 2021, the entire contents of which being incorporated herein by reference), a vehicle exterior communication unit 72 (as further described in U.S. application Ser. No. 17/156,631 filed Jan. 25, 2021, the entire contents of which being incorporated herein by reference), and a vehicle internal environment model and a peripheral device operation setting unit 140 (which is adapted according to an external model development process like that discussed in U.S. application Ser. No. 17/160,426, supra). That is, the arithmetic unit 110 configured as a single piece of hardware, or a plurality of networked processing resources, achieves functions of estimating the vehicle external environment, generating the route, and determining the target motion.

The cruise control system 100 of the present embodiment includes the arithmetic unit 110 that determines motions of the vehicle 1 to calculate a route to be traveled by the vehicle 1 and follow the route, so as to enable the assist driving and the autonomous driving. The arithmetic unit 110 is a microprocessor configured by one or more chips, and includes a CPU, a memory, and any other component. In the exemplary configuration of FIG. 3, the arithmetic unit 110 includes a processor and a memory. The memory stores memory modules (compartmentalized memory that holds different computer code that is readably and executable by the processor) which are each a software program executable by the processor. The functions of units of the arithmetic unit 110 shown in FIG. 4 are achieved, for example, by the processor executing the modules stored in the memory. In addition, the memory stores data of a model for use in the arithmetic unit 110. Note that a plurality of processors and a plurality of memories may be provided. Note that FIG. 4 shows a configuration to exert functions according to the present embodiment (route generating function described later), and does not necessarily show all the functions implemented in the arithmetic unit 110.

As shown in FIG. 4, the arithmetic unit 110 determines a target motion of the vehicle 1 based on outputs from a plurality of sensors and any other component, and controls actuation of the devices. The sensors and any other component that output information to the arithmetic unit 110 include (1) a plurality of cameras 70 provided to the body and any other part of the vehicle 1 and configured to take images of the environment outside the vehicle 1 (hereinafter, vehicle exterior environment); (2) a plurality of radars 71 provided to the body and any other part of the vehicle 1 and configured to detect an object and the like outside the vehicle 1; (3) a position sensor SW5 configured to detect the position of the vehicle 1 (vehicle position information) by using a global positioning system (GPS); (4) a vehicle status sensor SW6 configured to acquire a status of the vehicle 1, which includes outputs from sensors that detect the behavior of the vehicle, such as a vehicle speed sensor, an acceleration sensor, and a yaw rate sensor; (5) an occupant status sensor SW7 including an in-vehicle camera and the like and configured to acquire a status of an occupant in the vehicle 1; and (6) a driving operation information acquisition device SW0 configured to detect a driving operation of the driver. The accelerator position sensor SW1, the shift sensor SW2, the brake sensor SW3, and the steering angle sensor SW4 described above are examples of the driving operation information acquisition device SW0. In addition, the arithmetic unit 110 receives communication information from another vehicle around the subject vehicle or traffic information from a navigation system, through a vehicle exterior communication unit 72 connected to a network outside the vehicle.

The cameras 70 are arranged to image the surroundings of the vehicle 1 at 360° in the horizontal direction. Each camera 70 generates image data by capturing an optical image showing the vehicle exterior environment. Each camera 70 then outputs the image data generated to the arithmetic unit 110. The cameras 70 are examples of an out-of-vehicle information acquisition unit M1 that acquires information of the vehicle exterior environment.

The image data obtained by each camera 70 is also input to a human machine interface (HMI) unit 700, in addition to the arithmetic unit 110. The HMI unit 700 displays information based on the image data obtained, on a display device or the like in the vehicle.

The radars 71 are arranged so that the detection range covers 360° of the vehicle 1 in the horizontal direction, similarly to the cameras 70. The type of the radars 71 is not particularly limited. For example, a millimeter wave radar or an infrared radar can be adopted. The radars 71 are examples of an out-of-vehicle information acquisition unit M1 that acquires information of the vehicle exterior environment.

During the assist driving or the autonomous driving, the arithmetic unit 110 (or arithmetic circuitry 110) sets a traveling route of the vehicle 1 and sets a target motion of the vehicle 1 so as to follow the traveling route of the vehicle 1. The arithmetic unit 110 includes a vehicle exterior environment recognition unit 111 (or vehicle external environment recognition circuitry 111) that recognizes the vehicle exterior environment based on outputs from the cameras 70 and the like to set a target motion of the vehicle 1, a candidate route generation unit 112 (or candidate route generation circuitry 112) that calculates one or more candidate routes travelable by the vehicle 1 in accordance with the vehicle exterior environment recognized by the vehicle exterior environment recognition unit 111 (or vehicle external environment recognition circuitry 111), a vehicle behavior estimation unit 113 (or vehicle behavior estimation circuitry 113) that estimates a behavior of the vehicle 1 based on an output from the vehicle status sensor SW6, an occupant behavior estimation unit 114 (or occupant behavior estimation circuitry 114) that estimates a behavior of an occupant of the vehicle 1 based on an output from the occupant status sensor SW7, a route determination unit 115 (or route determination circuitry 115) that determines a route to be traveled by the vehicle 1, and a vehicle motion determination unit 116 (or vehicle motion determination circuitry 116) that determines a target motion of the vehicle 1 for following the route determined by the route determination unit 115. The candidate route generation unit 112, the vehicle behavior estimation unit 113, the occupant behavior estimation unit 114, and the route determination unit 115 constitute a route setting unit configured to set the route to be traveled by the vehicle 1, in accordance with the vehicle exterior environment recognized by the vehicle exterior environment recognition unit 111.

In addition, as safety functions, the arithmetic unit 110 includes a rule-based route generation unit 120 (or rule-based route generation circuitry 120) configured to recognize an object outside the vehicle according to a predetermined rule and generate a traveling route that avoids the object, and a backup unit 130 (or backup circuitry 130) configured to generate a traveling route that guides the vehicle 1 to a safety area such as a road shoulder.

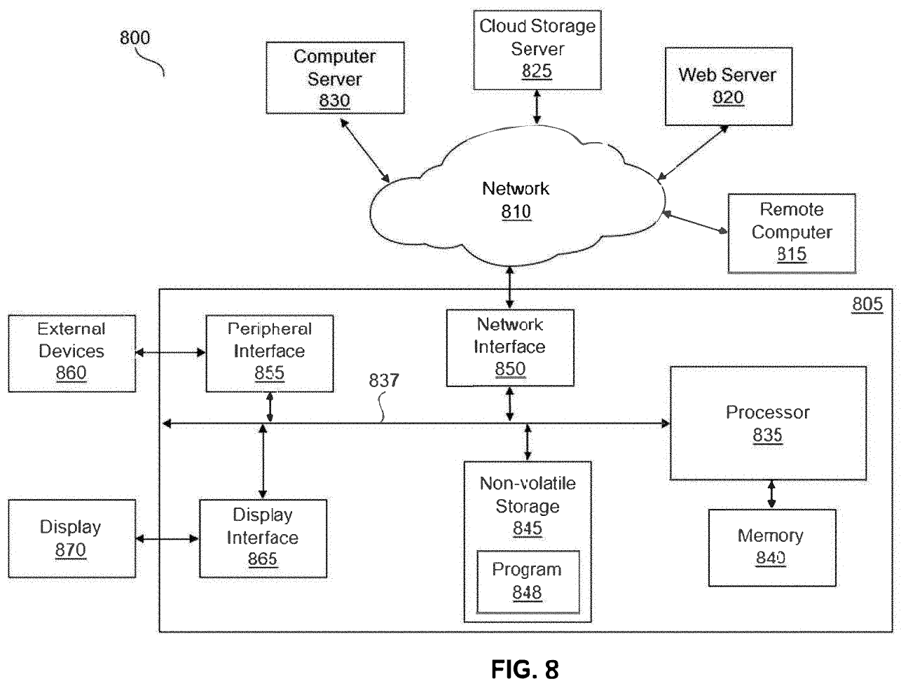

FIG. 8 illustrates a block diagram of a computer that may implement the various embodiments described herein.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or computer server, or any combination of these computing devices. The remote computer or computer server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 8 is a functional block diagram illustrating a networked system 800 of one or more networked computers and servers. In an embodiment, the hardware and software environment illustrated in FIG. 8 may provide an exemplary platform for implementation of the software and/or methods according to the present disclosure.

Referring to FIG. 8, a networked system 800 may include, but is not limited to, computer 805, network 810, remote computer 815, web server 820, cloud storage server 825 and computer server 830. In some embodiments, multiple instances of one or more of the functional blocks illustrated in FIG. 8 may be employed.

Additional detail of computer 805 is shown in FIG. 8. The functional blocks illustrated within computer 805 are provided only to establish exemplary functionality and are not intended to be exhaustive. And while details are not provided for remote computer 815, web server 820, cloud storage server 825 and computer server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm. Bus 837 may be a proprietary or industry standard high-speed parallel or serial peripheral interconnect bus, such as ISA, PCI, PCI Express (PCI-e), AGP, and the like. Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and computer server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

<Vehicle Exterior Environment Recognition Unit>

The vehicle exterior environment recognition unit 111 receives outputs from the cameras 70 and the radars 71 which are mounted on the vehicle 1 and recognizes the vehicle exterior environment. The recognized vehicle exterior environment includes at least a road and an obstacle. Here, it is assumed that the vehicle exterior environment recognition unit 111 recognizes the vehicle environment including the road and the obstacle by comparing the 3-dimensional information of the surroundings of the vehicle 1 with a vehicle external environment model, based on data from the cameras 70 and the radars 71. The vehicle external environment model is, for example, a learned model generated by deep learning, and allows recognition of a road, an obstacle, and the like with respect to 3-dimensional information of the surroundings of the vehicle.

In a non-limiting example, a process is described about how a learned model is trained, according to the present teachings. The example will be in the context of a vehicle external environment estimation circuitry (e.g., a trained model saved in a memory and applied by a computer). However, other aspects of the trained model for object detection/avoidance, route generation, controlling steering, braking, etc., are implemented via similar processes to acquire the learned models used in the components of the arithmetic unit 110. Hereinafter, as part of a process for determining how a computing device 1000 calculates a route path (R2, R13, R12, or R11 for example on a road 5) in the presence of an obstacle 3 (another vehicle) surrounded by a protection zone (see dashed line that encloses unshaded area) will be explained. In this example, the obstacle 3 is a physical vehicle that has been captured by a forward looking camera from the trailing vehicle 1. The model is hosted in a single information processing unit (or single information processing circuitry).

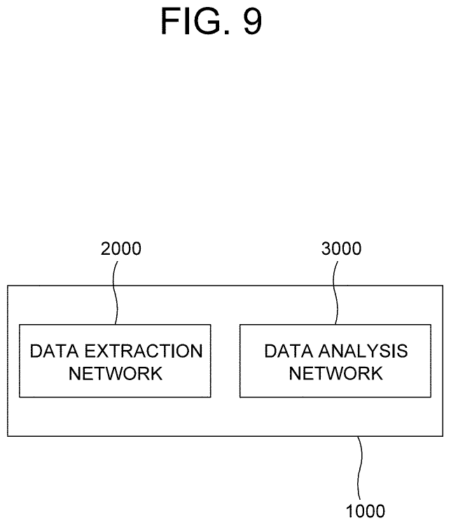

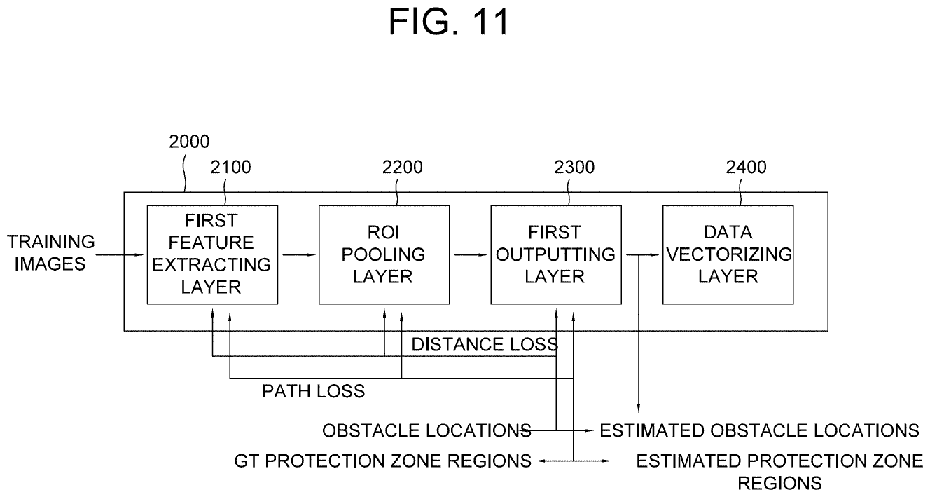

First, by referring to FIG. 9, a configuration of the computing device 1000 will be explained. The computing device 1000 may include a data extraction network 2000 and a data analysis network 3000. Further, to be illustrated in FIG. 11, the data extraction network 2000 may include at least one first feature extracting layer 2100, at least one Region-Of-Interest (ROI) pooling layer 2200, at least one first outputting layer 2300 and at least one data vectorizing layer 2400. And, also to be illustrated in FIG. 9, the data analysis network 3000 may include at least one second feature extracting layer 3100 and at least one second outputting layer 3200.

Below, an aspect of calculating a safe route (e.g. R13), around a protection zone that surrounds the obstacle will be explained. Moreover, the specific aspect is to learn a model to detect obstacles (e.g., vehicle 1) on a roadway, and also estimate relative distance to a superimposed protection range that has been electronically superimposed about the vehicle 3 in the image. To begin with, a first embodiment of the present disclosure will be presented.

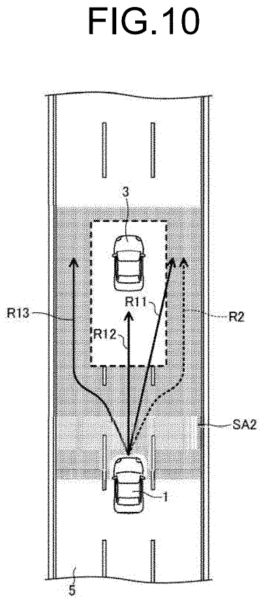

First, the computing device 1000 may acquire at least one subject image that includes a superimposed protection zone about the subject vehicle 3. By referring to FIG. 10, the subject image may correspond to a scene of a highway, photographed from a vehicle 1 that is approaching another vehicle 3 from behind on a three lane highway.

After the subject image is acquired, in order to generate a source vector to be inputted to the data analysis network 3000, the computing device 1000 may instruct the data extraction network 2000 to generate the source vector including (i) an apparent distance, which is a distance from a front of vehicle 1 to a back of the protection zone surrounding vehicle 3, and (ii) an apparent size, which is a size of the protection zone.

In order to generate the source vector, the computing device 1000 may instruct at least part of the data extraction network 2000 to detect the obstacle 3 (vehicle) and protection zone. Specifically, the computing device 1000 may instruct the first feature extracting layer 2100 to apply at least one first convolutional operation to the subject image, to thereby generate at least one subject feature map. Thereafter, the computing device 1000 may instruct the ROI pooling layer 2200 to generate one or more ROI-Pooled feature maps by pooling regions on the subject feature map, corresponding to ROIs on the subject image which have been acquired from a Region Proposal Network (RPN) interworking with the data extraction network 2000. And, the computing device 1000 may instruct the first outputting layer 2300 to generate at least one estimated obstacle location and one estimated protection zone region. That is, the first outputting layer 2300 may perform a classification and a regression on the subject image, by applying at least one first Fully-Connected (FC) operation to the ROI-Pooled feature maps, to generate each of the estimated obstacle location and protection zone region, including information on coordinates of each of bounding boxes. Herein, the bounding boxes may include the obstacle and a region around the obstacle (protection zone).

After such detecting processes are completed, by using the estimated obstacle location and the estimated protection zone location, the computing device 1000 may instruct the data vectorizing layer 2400 to subtract a y-axis coordinate (distance in this case) of an upper bound of the obstacle from a y-axis coordinate of the closer boundary of the protection zone to generate the apparent distance, and multiply a distance of the protection zone and a horizontal width of the protection zone to generate the apparent size of the protection zone.

After the apparent distance and the apparent size are acquired, the computing device 1000 may instruct the data vectorizing layer 2400 to generate at least one source vector including the apparent distance and the apparent size as its at least part of components. Then, the computing device 1000 may instruct the data analysis network 3000 to calculate an estimated actual protection zone by using the source vector. Herein, the second feature extracting layer 3100 of the data analysis network 3000 may apply second convolutional operation to the source vector to generate at least one source feature map, and the second outputting layer 3200 of the data analysis network 3000 may perform a regression, by applying at least one FC operation to the source feature map, to thereby calculate the estimated protection zone.

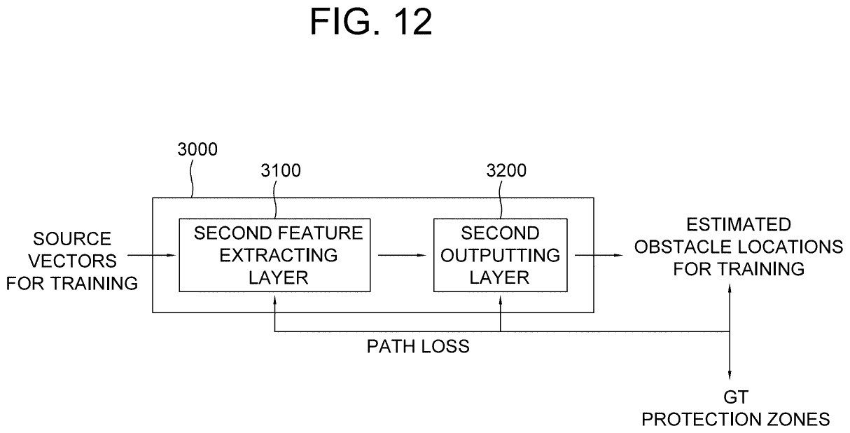

As shown above, the computing device 1000 may include two neural networks, i.e., the data extraction network 2000 and the data analysis network 3000. The two neural networks should be trained to perform the processes properly, and thus below it is described how to train the two neural networks by referring to FIG. 11 and FIG. 12.

First, by referring to FIG. 11, the data extraction network 2000 may have been trained by using (i) a plurality of training images corresponding to scenes of subject roadway conditions for training, photographed from fronts of the subject vehicles for training, including images of their corresponding projected protection zones (protection zones superimposed around a forward vehicle, or perhaps a forward vehicle with a ladder strapped on top of it, which is an “obstacle” on a roadway) for training and images of their corresponding grounds for training, and (ii) a plurality of their corresponding ground truth (GT) obstacle locations and GT protection zone regions. The protection zones do not occur naturally, but are previously superimposed about the vehicle 3 via another process, perhaps a bounding box by the camera. More specifically, the data extraction network 2000 may have applied aforementioned operations to the training images, and have generated their corresponding estimated obstacle locations and estimated protection zone regions. Then, (i) each of obstacle pairs of each of the estimated obstacle locations and each of their corresponding GT obstacle locations and (ii) each of obstacle pairs of each of the estimated protection zone locations associated with the obstacles and each of the GT protection zone locations may have been referred to, in order to generate at least one vehicle path loss and at least one distance, by using any of loss generating algorithms, e.g., a smooth-L1 loss algorithm and a cross-entropy loss algorithm. Thereafter, by referring to the distance loss and the path loss, backpropagation may have been performed to learn at least part of parameters of the data extraction network 2000. Parameters of the RPN can be trained also, but a usage of the RPN is a well-known prior art, thus further explanation is omitted.

Herein, the data vectorizing layer 2400 may have been implemented by using a rule-based algorithm, not a neural network algorithm. In this case, the data vectorizing layer 2400 may not need to be trained, and may just be able to perform properly by using its settings inputted by a manager.

As an example, the first feature extracting layer 2100, the ROI pooling layer 2200 and the first outputting layer 2300 may be acquired by applying a transfer learning, which is a well-known prior art, to an existing object detection network such as VGG or ResNet, etc. Second, by referring to FIG. 12, the data analysis network 3000 may have been trained by using (i) a plurality of source vectors for training, including apparent distances for training and apparent sizes for training as their components, and (ii) a plurality of their corresponding GT protection zones. More specifically, the data analysis network 3000 may have applied aforementioned operations to the source vectors for training, to thereby calculate their corresponding estimated protection zones for training. Then each of distance pairs of each of the estimated protection zones and each of their corresponding GT protection zones may have been referred to, in order to generate at least one distance loss, by using said any of loss algorithms. Thereafter, by referring to the distance loss, backpropagation can be performed to learn at least part of parameters of the data analysis network 3000.

After performing such training processes, the computing device 1000 can properly calculate the estimated protection zone by using the subject image including the scene photographed from the front of the subject roadway.

Hereafter, another embodiment will be presented. A second embodiment is similar to the first embodiment, but different from the first embodiment in that the source vector thereof further includes a tilt angle, which is an angle between an optical axis of a camera which has been used for photographing the subject image (e.g., the subject obstacle) and a distance to the obstacle. Also, in order to calculate the tilt angle to be included in the source vector, the data extraction network of the second embodiment may be slightly different from that of the first one. In order to use the second embodiment, it should be assumed that information on a principal point and focal lengths of the camera are provided.

Specifically, in the second embodiment, the data extraction network 2000 may have been trained to further detect lines of a road in the subject image, to thereby detect at least one vanishing point of the subject image. Herein, the lines of the road may denote lines representing boundaries of the road located on the obstacle in the subject image, and the vanishing point may denote where extended lines generated by extending the lines of the road, which are parallel in the real world, are gathered. As an example, through processes performed by the first feature extracting layer 2100, the ROI pooling layer 2200 and the first outputting layer 2300, the lines of the road may be detected.

After the lines of the road are detected, the data vectorizing layer 2400 may find at least one point where the most extended lines are gathered, and determine it as the vanishing point. Thereafter, the data vectorizing layer 2400 may calculate the tilt angle by referring to information on the vanishing point, the principal point and the focal lengths of the camera by using a following formula:

θₜᵢₗₜ=atan2(vy−cy, fy)

In the formula, vy may denote a y-axis (distance direction) coordinate of the vanishing point, cy may denote a y-axis coordinate of the principal point, and fy may denote a y-axis focal length. Using such formula to calculate the tilt angle is a well-known prior art, thus more specific explanation is omitted.

After the tilt angle is calculated, the data vectorizing layer 2400 may set the tilt angle as a component of the source vector, and the data analysis network 3000 may use such source vector to calculate the estimated protection zone. In this case, the data analysis network 3000 may have been trained by using the source vectors for training additionally including tilt angles for training.

For a third embodiment which is mostly similar to the first one, some information acquired from a subject obstacle DB storing information on subject obstacles, including the subject obstacle, can be used for generating the source vector. That is, the computing device 1000 may acquire structure information on a structure of the subject vehicle, e.g., 4 doors, vehicle base length of a certain number of feet, from the subject vehicle DB. Or, the computing device 1000 may acquire topography information on a topography of a region around the subject vehicle, e.g., hill, flat, bridge, etc., from location information for the particular roadway. Herein, at least one of the structure information and the topography information can be added to the source vector by the data vectorizing layer 2400, and the data analysis network 3000, which has been trained by using the source vectors for training additionally including corresponding information, i.e., at least one of the structure information and the topography information, may use such source vector to calculate the estimated protection zone.

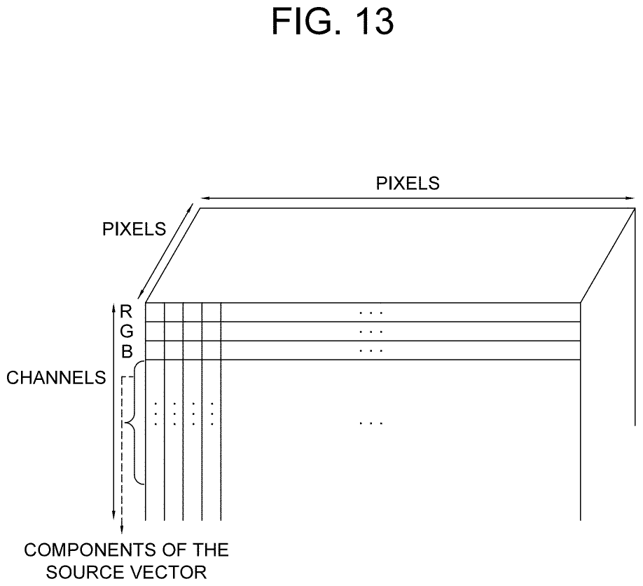

As a fourth embodiment, the source vector, generated by using any of the first to the third embodiments, can be concatenated channel-wise to the subject image or its corresponding subject segmented feature map, which has been generated by applying an image segmentation operation thereto, to thereby generate a concatenated source feature map, and the data analysis network 3000 may use the concatenated source feature map to calculate the estimated protection zone. An example configuration of the concatenated source feature map may be shown in FIG. 13. In this case, the data analysis network 3000 may have been trained by using a plurality of concatenated source feature maps for training including the source vectors for training, other than using only the source vectors for training. By using the fourth embodiment, much more information can be inputted to processes of calculating the estimated protection zone, thus it can be more accurate. Herein, if the subject image is used directly for generating the concatenated source feature map, it may require too much computing resources, thus the subject segmented feature map may be used for reducing a usage of the computing resources.

Descriptions above are explained under an assumption that the subject image has been photographed from the back of the subject vehicle, however, embodiments stated above may be adjusted to be applied to the subject image photographed from other sides of the subject vehicle. And such adjustment will be easy for a person in the art, referring to the descriptions.

For example, the vehicle exterior environment recognition unit 111 identifies a free space, that is, an area without an object, by processing images captured by the cameras 70. In this image processing, for example, a learned model generated by deep learning is used, such as according to the processes discussed above with respect to FIG. 9 through FIG. 13. Then, a 2-dimensional map representing the free space is generated. In addition, the vehicle exterior environment recognition unit 111 acquires information of an object around the vehicle 1 from outputs of the radars 71. This information is positioning information containing the position, the speed, and any other element of the object. Then, the vehicle exterior environment recognition unit 111 combines the 2-dimensional map thus generated with the positioning information of the object to generate a 3-dimensional map representing the surroundings of the vehicle 1. This process uses information of the installation positions of and the shooting directions of the cameras 70, and information of the installation positions of and the transmission direction of the radars 71. The vehicle exterior environment recognition unit 111 then compares the generated 3-dimensional map with the vehicle external environment model to recognize the vehicle environment including the road and the obstacle. Note that the deep learning uses a multilayer neural network (deep neutral network (DNN)). An example of the multilayer neural network is convolutional neural network (CNN).

<Candidate Route Generation Unit>

The candidate route generation unit 112 generates candidate routes that can be traveled by the vehicle 1, based on an output from the vehicle exterior environment recognition unit 111, an output from the position sensor SW5, and information transmitted from the vehicle exterior communication unit 72. For example, the candidate route generation unit 112 generates a traveling route that avoids the obstacle recognized by the vehicle exterior environment recognition unit 111, on the road recognized by the vehicle exterior environment recognition unit 111. The output from the vehicle exterior environment recognition unit 111 includes, for example, traveling road information related to a traveling road on which the vehicle 1 travels. The traveling road information includes information related to the shape of the traveling road itself and information related to objects on the traveling road. The information related to the shape of the traveling road includes the shape of the traveling road (whether it is straight or curved, and the curvature), the width of the traveling road, the number of lanes, and the width of each lane. The information related to the objects includes the positions and speeds of the objects relative to the vehicle, and the attributes (e.g., the type or the moving directions) of the objects. Examples of the object types include a vehicle, a pedestrian, a road, and a section line.

Here, it is assumed that the candidate route generation unit 112 calculates a plurality of candidate routes by means of a state lattice method, and selects one or more candidate routes from among these candidate routes based on a route cost of each candidate route. However, the routes may be calculated by means of a different method.

The candidate route generation unit 112 sets a virtual grid area on the traveling road based on the traveling road information. The grid area has a plurality of grid points. Each grid point identifies the position on the traveling road. The candidate route generation unit 112 sets a predetermined grid point as a destination. Then, a plurality of candidate routes are calculated by a route search involving a plurality of grid points in the grid area. In the state lattice method, a route branches from a certain grid point to random grid points ahead in the traveling direction of the vehicle. Therefore, each candidate route is set so as to sequentially pass a plurality of grid points. Each candidate route includes time information indicating a time of passing each grid point, speed information related to the speed, acceleration, and any other element at each grid point, and information related to other vehicle motions.

The candidate route generation unit 112 selects one or more traveling routes from the plurality of candidate routes based on the route cost. The route cost herein includes, for example, the lane-centering degree, the acceleration of the vehicle, the steering angle, and the possibility of collision. Note that, when the candidate route generation unit 112 selects a plurality of traveling routes, the route determination unit 115 selects one of the traveling routes.

<Vehicle Behavior Estimation Unit>

The vehicle behavior estimation unit 113 measures a status of the vehicle, from the outputs of sensors which detect the behavior of the vehicle, such as a vehicle speed sensor, an acceleration sensor, and a yaw rate sensor. The vehicle behavior estimation unit 113 generates a six-degrees-of-freedom (i.e., 6DoF) model of the vehicle indicating the behavior of the vehicle.

Here, the 6DoF model of the vehicle is obtained by modeling acceleration along three axes, namely, in the “forward/backward (surge)”, “left/right (sway)”, and “up/down (heave)” directions of the traveling vehicle, and the angular velocity along the three axes, namely, “pitch”, “roll”, and “yaw”. That is, the 6DoF model of the vehicle is a numerical model that not only includes the vehicle motion on the plane (the forward/backward and left/right directions (i.e., the movement along the X-Y plane) and the yawing (along the Z-axis)) according to the classical vehicle motion engineering, but also reproduces the behavior of the vehicle using six axes in total. The vehicle motions along the six axes further include the pitching (along the Y-axis), rolling (along the X-axis) and the movement along the Z-axis (i.e., the up/down motion) of the vehicle body mounted on the four wheels with the suspension interposed therebetween.

The vehicle behavior estimation unit 113 applies the 6DoF model of the vehicle to the traveling route generated by the candidate route generation unit 112 to estimate the behavior of the vehicle 1 when following the traveling route.

<Occupant Behavior Estimation Unit>

The occupant behavior estimation unit 114 specifically estimates the driver's health condition and emotion from a detection result from the occupant status sensor SW7. Examples of the health conditions include good condition, slightly tired condition, poor condition, and less conscious condition. Examples of the emotions include happy, normal, bored, annoyed, and uncomfortable emotions.

For example, the occupant behavior estimation unit 114 extracts a face image of the driver from an image captured by a camera installed inside the vehicle cabin, and identifies the driver. The extracted face image and information of the identified driver are provided as inputs to a human model. The human model is, for example, a learned model generated by deep learning, and outputs the health condition and the emotion of each person who may be the driver of the vehicle 1, from the face image. The occupant behavior estimation unit 114 outputs the health condition and the emotion of the driver output by the human model. Details of such estimation are disclosed in U.S. Pat. No. 10,576,989, which entire contents of which is hereby incorporated by reference.

In addition, in a case of adopting a bio-information sensor, such as a skin temperature sensor, a heartbeat sensor, a blood flow sensor, and a perspiration sensor, as the occupant status sensor SW7 for acquiring information of the driver, the occupant behavior estimation unit measures the bio-information of the driver from the output from the bio-information sensor. In this case, the human model uses the bio-information as the input, and outputs the health condition and the emotion of each person who may be the driver of the vehicle 1. The occupant behavior estimation unit 114 outputs the health condition and the emotion of the driver output by the human model.

In addition, as the human model, a model that estimates an emotion of a human in response to the behavior of the vehicle 1 may be used for each person who may be the driver of the vehicle 1. In this case, the model may be constructed by managing, in time sequence, the outputs of the vehicle behavior estimation unit 113, the bio-information of the driver, and the estimated emotional states. This model allows, for example, the relationship between changes in the driver's emotion (the degree of wakefulness) and the behavior of the vehicle to be predicted.

The occupant behavior estimation unit 114 may include a human body model as the human model. The human body model specifies, for example, the weight of the head (e.g., 5 kg) and the strength of the muscles around the neck supporting against G-forces in the front, back, left, and right directions. The human body model outputs a predicted physical condition and subjective viewpoint of the occupant, when a motion (acceleration G-force or jerk) of the vehicle body is input. Examples of the physical condition of the occupant include comfortable/moderate/uncomfortable conditions, and examples of the subjective viewpoint include whether a certain event is unexpected or predictable. For example, a vehicle behavior that causes the head to lean backward even slightly is uncomfortable for an occupant. Therefore, a traveling route that causes the head to lean backward can be avoided by referring to the human body model. On the other hand, a vehicle behavior that causes the head of the occupant to lean forward in a bowing manner does not immediately lead to discomfort. This is because the occupant is easily able to resist such a force. Therefore, such a traveling route that causes the head to lean forward may be selected. Alternatively, referring to the human body model allows a target motion to be determined so that, for example, the head of the occupant does not swing, or to be dynamically determined so that the occupant is active.

The occupant behavior estimation unit 114 applies a human model to the vehicle behavior estimated by the vehicle behavior estimation unit 113 to estimate a change in the health conditions or the feeling of the current driver with respect to the vehicle behavior.

<Route Determination unit>

The route determination unit 115 determines the route along which the vehicle 1 is to travel, based on an output from the occupant behavior estimation unit 114. If the number of routes generated by the candidate route generation unit 112 is one, the route determination unit 115 determines that route as the route to be traveled by the vehicle 1. If the candidate route generation unit 112 generates a plurality of routes, a route that the occupant (in particular, the driver) feels most comfortable with, that is, a route that the driver does not perceive as a redundant route, such as a route too cautiously avoiding an obstacle, is selected out of the plurality of candidate routes, in consideration of an output from the occupant behavior estimation unit 114.

<Rule-Based Route Generation Unit>

The rule-based route generation unit 120 recognizes an object outside the vehicle in accordance with a predetermined rule based on outputs from the cameras 70 and radars 71, without use of deep learning, and generates a traveling route that avoids such an object. Similarly to the candidate route generation unit 112, it is assumed that the rule-based route generation unit 120 also calculates a plurality of candidate routes by means of the state lattice method, and selects one or more candidate routes from among these candidate routes based on a route cost of each candidate route. In the rule-based route generation unit 120, the route cost is calculated based on, for example, a rule of preventing the vehicle from entering an area within several meters from the object. Another technique may be used for calculation of the route also in this rule-based route generation unit 120. Details of the route generation unit 120 may be found, e.g., in co-pending U.S. application Ser. No. 17/123,116, the entire contents of which is hereby incorporated by reference.

Information of a route generated by the rule-based route generation unit 120 is input to the vehicle motion determination unit 116.

<Backup Unit>

The backup unit 130 generates a traveling route that guides the vehicle 1 to a safe area such as the road shoulder, based on outputs from the cameras 70 and radars 71, in an occasion of failure of a sensor or any other component, or when the occupant is not feeling well. For example, from the information given by the position sensor SW5, the backup unit 130 sets a safety area in which the vehicle 1 can be stopped in case of emergency, and generates a traveling route to reach the safety area. Similarly to the candidate route generation unit 112, it is assumed that the backup unit 130 also calculates a plurality of candidate routes by means of the state lattice method, and selects one or more candidate routes from among these candidate routes based on a route cost of each candidate route. Another technique may be used for calculation of the route also in this backup unit 130.

Information of a route generated by the backup unit 130 is input to the vehicle motion determination unit 116.

<Vehicle Motion Determination unit>

The vehicle motion determination unit 116 determines a target motion on a traveling route determined by the route determination unit 115. The target motion means steering and acceleration/deceleration to follow the traveling route. In addition, with reference to the 6DoF model of the vehicle, the vehicle motion determination unit 116 calculates the motion of the vehicle body on the traveling route selected by the route determination unit 115.

The vehicle motion determination unit 116 determines the target motion to follow the traveling route generated by the rule-based route generation unit 120.

The vehicle motion determination unit 116 determines the target motion to follow the traveling route generated by the backup unit 130.

When the traveling route determined by the route determination unit 115 significantly deviates from a traveling route generated by the rule-based route generation unit 120, the vehicle motion determination unit 116 selects the traveling route generated by the rule-based route generation unit 120 as the route to be traveled by the vehicle 1.

In an occasion of failure of sensors or any other component (in particular, cameras 70 or radars 71) or in a case where the occupant is not feeling well, the vehicle motion determination unit 116 selects the traveling route generated by the backup unit 130 as the route to be traveled by the vehicle 1.

<Physical Amount Calculation Unit>

A physical amount calculation unit includes a driving force calculation unit 117, a braking force calculation unit 118, and a steering amount calculation unit 119. To achieve the target motion, the driving force calculation unit 117 calculates a target driving force to be generated by the powertrain devices (the engine 10 and the transmission 20). To achieve the target motion, the braking force calculation unit 118 calculates a target braking force to be generated by the brake device 30. To achieve the target motion, the steering amount calculation unit 119 calculates a target steering amount to be generated by the steering device 40. Details of the physical amount calculation unit may be found, e.g., in co-pending U.S. application Ser. No. 17/159,175, the entirety of which is hereby incorporated by reference.

<Peripheral Device Operation Setting Unit>

A peripheral device operation setting unit 140 sets operations of body-related devices of the vehicle 1, such as lamps and doors, based on outputs from the vehicle motion determination unit 116. The peripheral device operation setting unit 140 determines, for example, the directions of lamps, while the vehicle 1 follows the traveling route determined by the route determination unit 115. In addition, for example, at a time of guiding the vehicle 1 to the safety area set by the backup unit 130, the peripheral device operation setting unit 140 sets operations so that the hazard lamp is turned on and the doors are unlocked after the vehicle 1 reaches the safety area.

<Output Destination of Arithmetic Unit>

An arithmetic result of the arithmetic unit 110 is output to the powertrain ECU 200, the brake microcomputer 300, the EPAS microcomputer 500, and a body-related microcomputer 600. Specifically, information related to the target driving force calculated by the driving force calculation unit 117 is input to the powertrain ECU 200. Information related to the target braking force calculated by the braking force calculation unit 118 is input to the brake microcomputer 300. Information related to the target steering amount calculated by the steering amount calculation unit 119 is input to the EPAS microcomputer 500. Information related to the operations of the body-related devices (body-related device circuitry) set by the peripheral device operation setting unit 140 is input to the body-related microcomputer 600. In the following description, the powertrain ECU 200, the brake microcomputer 300, the EPAS microcomputer 500, and the body-related microcomputer 600 may be collectively referred to as a “control unit 800.”

As described hereinabove, the powertrain ECU 200 basically calculates fuel injection timing for the injector 12 and ignition timing for the spark plug 13 so as to achieve the target driving force, and outputs control signals to these relevant traveling devices. The brake microcomputer 300 basically calculates a controlled variable of the brake actuator 33 so as to achieve the target driving force, and outputs a control signal to the brake actuator 33. The EPAS microcomputer 500 basically calculates an electric current amount to be supplied to the EPAS device 42 so as to achieve the target steering amount, and outputs a control signal to the EPAS device 42.

As described hereinabove, in the present embodiment, the arithmetic unit 110 only calculates the target physical amount to be output from each traveling device, and the controlled variables of traveling devices are calculated by the device controllers 200 to 500. This reduces the amount of calculation by the arithmetic unit 110, and improves the speed of calculation by the arithmetic unit 110. In addition, since each of the device controllers 200 to 500 simply has to calculate the actual controlled variables and output control signals to the traveling devices (injector 12 and any other component), the processing speed is fast. As a result, the responsiveness of the traveling devices to the vehicle exterior environment can be improved.

In addition, by having the device controllers 200 to 500 calculate the controlled variables, the calculation speed of the arithmetic unit 110 can be slower than those of the device controllers 200 to 500, because the arithmetic unit 110 only needs to roughly calculate physical amounts. Thus, the accuracy of calculation by the arithmetic unit 110 is improved.

As shown in FIG. 4, in the present embodiment, the powertrain ECU 200, the brake microcomputer 300, the DSC microcomputer 400, and the EPAS microcomputer 500 are configured to be capable of communicating with one another. The powertrain ECU 200, the brake microcomputer 300, the DSC microcomputer 400, and the EPAS microcomputer 500 share information related to the control variables of the traveling devices with one another, and are configured to be capable of executing control to allow the traveling devices to cooperate with one another.

Thus, for example, while a road surface is slippery, the need arises to reduce the rotation of the wheels (to perform so-called traction control) to prevent the wheels from spinning. To reduce spinning of the wheels, the output of the powertrain may be reduced, or the braking force of the brake device 30 may be used. However, since the powertrain ECU 200 and the brake microcomputer 300 are capable of communicating with each other, an optimum countermeasure can be taken using both of the powertrain and the brake device 30.

In addition, for example, if, when the vehicle 1 is to corner, the control variables of the powertrain and the brake device 30 (including the DSC device 36) are finely adjusted in accordance with the target steering amount, rolling and pitching that causes a front portion of the vehicle 1 to move downward are induced in synchronization with each other to give rise to diagonal rolling. Giving rise to the diagonal rolling increases the load applied to the outer front wheel 50. This allows the vehicle to corner with small steering angle, and can reduce the rolling resistance to the vehicle 1.

In another example, under vehicle stabilization control (dynamic stability control), if a difference exists between each of a target yaw rate and a target lateral acceleration calculated as those of the vehicle 1 that is ideally cornering, based on the current steering angle and the vehicle speed, and an associated one of the current yaw rate and the current lateral acceleration, the brake devices 30 for the four wheels are individually operated, or the output of the powertrain is regulated, so that these values return to the target values. The DSC microcomputer 400 has had to comply with a communication protocol, and has acquired information related to instability of the vehicle from a yaw rate sensor and a wheel speed sensor through a relatively low speed controller area network (CAN). The DSC microcomputer 400 has further instructed the powertrain ECU 200 and the brake microcomputer 300 to operate through the CAN. Thus, a large amount of time has been required. In the present embodiment, information related to the controlled variables can be directly exchanged among the microcomputers. Thus, the period from the detection of the instability of the vehicle to the stability control, i.e., braking of the wheels or the start of regulation of the output, can be remarkably shortened. Although stability control performed while the driver countersteers has been relaxed based on his/her expectations, the stability control can be relaxed in real time with reference to the steering velocity provided by the EPAS microcomputer 500 and other elements.

In still another example, in the case of a high-powered front-wheel-drive vehicle, output control interlocked with the steering angle may be performed to reduce the output of the powertrain while the accelerator is stepped on with a large steering angle, thereby preventing the vehicle from becoming instable beforehand. This control can also reduce the output as soon as the powertrain ECU 200 refers to the steering angle and steering angle signal in the EPAS microcomputer 500. This can provide a driving feel that is suitable for the driver without being recognized as sudden intervention.

<Reflection of Driving Operation Information of Driver>

The present embodiment is characterized in that operation input information which has been input to the control unit 800 in the known art (a mode in which driving has not been automated) and which is related to the driver's operations entered into the driving operation information acquisition device SW0 is imparted to the arithmetic unit 110 as well. In other words, the present embodiment is characterized in that the operation input information is input to both of the arithmetic unit 110 and the control unit 800 in parallel. The operation input information related to the driver's operations entered into the driving operation information acquisition device SW0 is an example of the driving operation information.

The arithmetic unit 110 may be configured to reflect an input from the driving operation information acquisition device SW0 in the route that is to be determined by the route determination unit 115, for example.

For example, if, during autonomous driving, a plurality of travelable candidate routes are calculated, one of the candidate routes to be travelled by the vehicle 1 may be finally determined in accordance with the operation amount and direction of the steering wheel 41 detected by the steering angle sensor SW4.

For example, if, during autonomous driving, the driver wants to slightly reduce the speed of the motor vehicle to see the scenery or to check ambient conditions, or unexpectedly wants to drop by a facility that has come into sight or any other place, the driver's intention may be reflected in an output from the arithmetic unit 110 when the driver operates the driving operation acquisition device SW0. For example, if the driver operates the brake pedal 31, control may be performed to gradually reduce the vehicle speed from the speed determined by the vehicle motion determination unit 116. In this case, the driver's intention may be reflected in a process performed by the vehicle motion determination unit 116, or may be reflected in calculation performed by the braking force calculation unit 118 at a later stage.

Furthermore, in the present embodiment, the output of the driving operation information acquisition device SW0 is input to the control unit 800 as well.

In the control unit 800, the driving operation information received from the driving operation information acquisition device SW0 can be used for verification, correction, or any other process of the calculation result obtained by the arithmetic unit 110. For example, comparisons between target physical amounts output from the driving force calculation unit 117, the braking force calculation unit 118, and the steering amount calculation unit 119, and the associated physical amounts calculated in the control unit 800 (hereinafter referred to as the “known physical amounts”) allow the calculation results obtained by the calculation units 117 to 119 to be reviewed for correctness. Then, for example, if the difference between the target physical amount output from each of the calculation units 117 to 119 and an associated one of the known physical amounts exceeds a predetermined reference value determined in advance, correction can be performed through a request made of the arithmetic unit 110 for another calculation or through adjustment of the difference between the target physical amount and the associated known physical amount. If the driving of the motor vehicle that has been driven to provide the known physical amounts (without driving automation) is switched to autonomous driving, the timing of this transition may be adjusted to prevent the driver from feeling uncomfortable. For example, this switching may be made if the difference between the target physical amount and the associated known physical amount is smaller than or equal to the predetermined reference value. The same statement applies to a situation where, contrary to the foregoing situation, switching is made from autonomous driving to a state “without driving automation.”

<Control To Be Performed in Event of Abnormal Conditions>

Next, control to be performed in the event of abnormal conditions will be described.

During traveling of the vehicle 1, abnormal conditions related to the traveling of the vehicle 1, such as knocking in the engine 10 or slipping of the front wheels 50, may occur. When such an abnormal condition has occurred, each traveling device needs to be quickly controlled to eliminate the abnormal condition. As described above, the arithmetic unit 110 recognizes the vehicle exterior environment using deep learning, and performs a huge amount of calculation to calculate the route of the vehicle 1. Thus, calculation performed through the arithmetic unit 110 to eliminate the abnormal condition may delay addressing the need.

To address this problem, in the present embodiment, when an abnormal condition related to the traveling of the vehicle 1 is detected, the device controllers 200 to 500 calculate the controlled variables of the associated traveling devices without using the arithmetic unit 110 to eliminate the abnormal condition, and output the resultant control signals to the associated traveling devices.

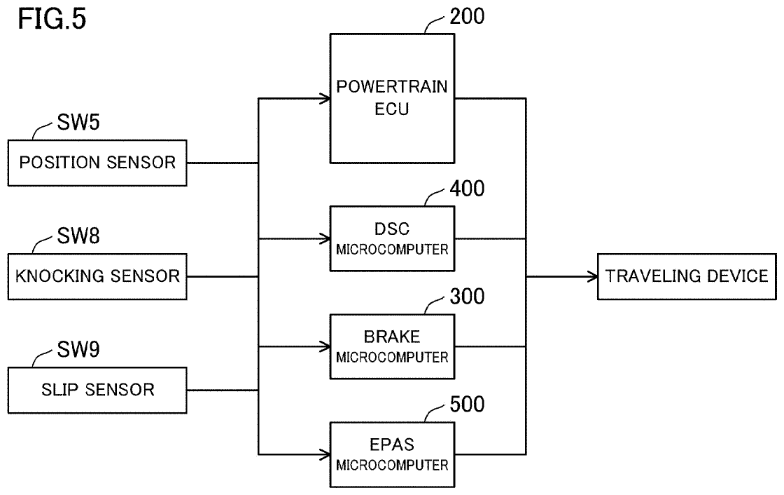

FIG. 5 shows an example of the relationship between each of sensors SW5, SW8, and SW9 detecting abnormal conditions related to the traveling of the vehicle 1 and the device controllers 200, 300, 400, and 500 (or device circuitry 200, 300, 400, and 500). In FIG. 5, examples of the sensors detecting abnormal conditions related to the traveling of the vehicle 1 include the position sensor SW5, the knocking sensor SW8, and the slip sensor SW9. However, sensors except these sensors may be provided. Known sensors can be used as the knocking sensor SW8 and the slip sensor SW9. Alternatively, for example, outputs from the sensors forming the driving operation information acquisition device SW0 (the accelerator position sensor SW1, the shift sensor SW2, the brake sensor SW3, and the steering angle sensor SW4) may be used.

For example, when knocking is detected by the knocking sensor SW8, a detection signal is input to each of the device controllers 200 to 500 (in particular, the powertrain ECU 200). After the detection signal is input, for example, the powertrain ECU 200 adjusts the fuel injection timing for the injector 12 and ignition timing for the spark plug 13, thereby reducing knocking. Meanwhile, the powertrain ECU 200 calculates the controlled variables of the traveling devices while allowing the driving force output from the powertrain to differ from the target driving force. At this time, for example, outputs from the driving operation information acquisition device SW0 may be used. For example, if the driving force differs from the target driving force, and significantly deviates from the driving force produced by the driver's operation, the vehicle speed may be adjusted in accordance with the difference from the speed associated with the target driving force so that the driver is less likely to feel uncomfortable.

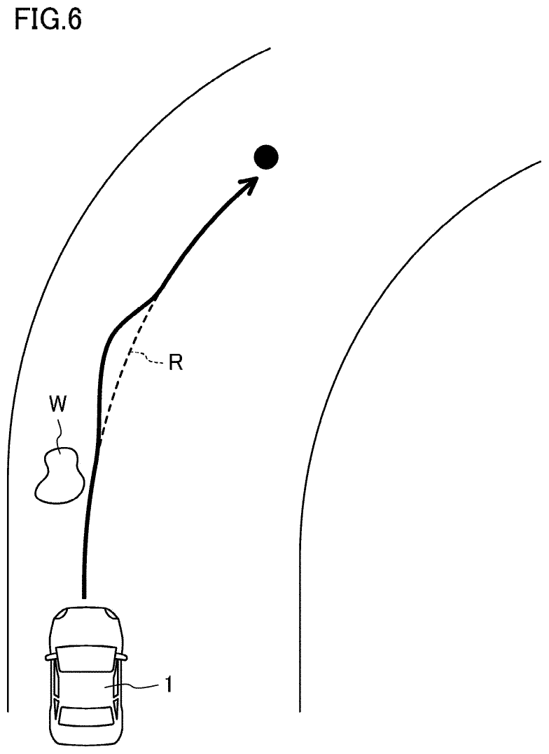

FIG. 6 illustrates an example of the behavior of the vehicle 1 that is slipping. In FIG. 6, the solid line indicates an actual traveling route of the vehicle 1, and the dotted line indicates a traveling route set by the arithmetic unit 110 (hereinafter referred to as a “theoretical traveling route R”). In FIG. 6, the solid and dotted lines partially overlap with each other. In FIG. 6, the filled circle indicates a target location of the vehicle 1.

Suppose that as shown in FIG. 6, a puddle W is formed at a location along the traveling route of the vehicle 1, and the front wheels of the vehicle 1 enter the puddle W to slip. In this case, as shown in FIG. 6, the vehicle 1 temporarily deviates from the theoretical traveling route R. The slipping of the front wheels of the vehicle 1 is detected by the slip sensor SW9 (see FIG. 5), and a deviation from the theoretical traveling route R is detected by the position sensor SW5 (see FIG. 5). The resultant detection signals are input to the associated device controllers 200 to 500. Thereafter, for example, the brake microcomputer 300 actuates the brake actuator 33 so as to increase the braking force of the front wheels. In addition, the EPAS microcomputer 500 actuates the EPAS device 42 so as to return the vehicle 1 to the theoretical traveling route R. At this time, communication between the brake microcomputer 300 and the EPAS microcomputer 500 can optimize the controlled variable of the EPAS device 42 with consideration given to the braking force generated by the brake device 30. Thus, as shown in FIG. 6, the vehicle 1 can be quickly and smoothly returned to the theoretical traveling route R to stabilize the traveling of the vehicle 1. Meanwhile, the driver may operate the steering wheel in haste. In this case, the speed at which the vehicle 1 is returned to the theoretical traveling route R may be adjusted in response to the steering of the driver. For example, if the driver steers the vehicle to the degree to which the vehicle travels past the theoretical traveling route R, the vehicle may accordingly pass the theoretical traveling route R once, and then may be operated to gradually return to the theoretical traveling route R.

As can be seen, when an abnormal condition related to the traveling of the vehicle 1 is detected, the device controllers 200 to 500 calculate the controlled variables of the associated traveling devices without using the arithmetic unit 110 to eliminate the abnormal condition, and output the resultant control signals to the associated traveling devices. This can improve the responsiveness of the traveling devices to the vehicle exterior environment. In addition, the uncomfortable feeling caused by the behavior of the vehicle 1 corresponding to the driver's own operation can be reduced.

In summary, in the present embodiment, the arithmetic unit 110 and the device controllers (the control unit 800) are provided. The arithmetic unit 110 generates a route which is located on the road and which avoids the obstacle, based on outputs from the vehicle exterior information acquisition device M1 including the cameras 70 and the radars 71, determines a target motion of the motor vehicle during the traveling of the motor vehicle along the route, and calculates the physical momentums of the traveling devices for achieving the target motion. The device controllers generate actuation control signals for controlling actuations of the traveling devices mounted in the motor vehicle, based on the calculation results of the arithmetic unit 110, and output the generated actuation control signals to the traveling devices (e.g., the engine 10, the transmission 20, the brake device 30, and the steering device 40). Then, the driving operation information on operations performed by the driver is given to each of the arithmetic unit 110 and the device controllers. In the arithmetic unit 110, the driving operation information is reflected in the calculation results of the physical momentums. In the device controllers, the driving operation information is reflected in control of the actuations of the traveling devices.

As can be seen, in the arithmetic unit 110, the driving operation information is reflected in the calculation results of the physical momentums. This can prevent the driver from feeling uncomfortable about the timing and degree of the driver assistance intervention. For example, if the calculation results of the physical momentums contrary to the driver's operation have been obtained, control can be performed to shift the timing of the driver assistance intervention, or to gradually increase the assist amount or the proportion of control for autonomous driving. In addition, for example, at the point in time when a value obtained by the driver's operation and the associated calculation result obtained by the arithmetic unit 110 are relatively close to each other, an operation, such as the driver assistance intervention, can be performed. Control that reflects a driver's intention without impairing the driver's comfort can be achieved even if the motor vehicle intervenes in driving (e.g., in the case of adopting autonomous driving).

Furthermore, when the device controllers each generate an actuation control signal for the associated traveling device, the driving operation information is reflected in the associated physical momentums calculated by the arithmetic unit 110. This allows the output result of the arithmetic unit 110 to be reviewed or corrected, and allows switching to be made from autonomous driving to manual driving.

(Second Embodiment)

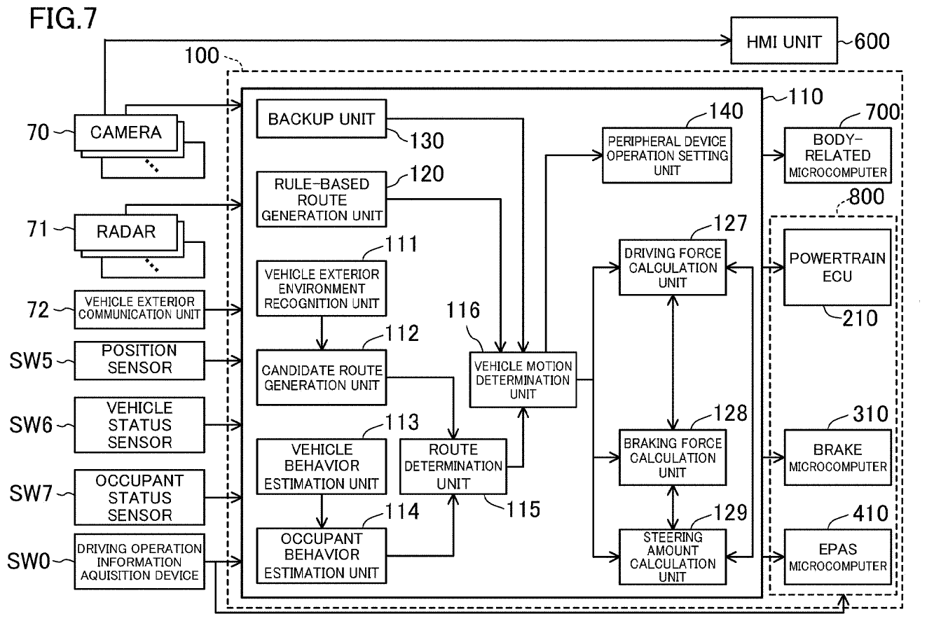

FIG. 7 schematically shows a block configuration of a control system of a vehicle 1 according to the present embodiment. In FIG. 7, the same reference numerals as those in FIG. 4 are used to represent equivalent components. In the following description, the equivalent components will not be described.

The configuration of FIG. 7 is different from that of FIG. 4 in that a driving force calculation unit 127, a braking force calculation unit 128, and a steering amount calculation unit 129 operate cooperatively in an arithmetic unit 110. Operations of a powertrain ECU 210, a brake microcomputer 310, and an EPAS microcomputer 410 are different from those in FIG. 1.

<Physical Amount Calculation Unit>

Just like the case shown in FIG. 4, to achieve a target motion, the driving force calculation unit 127 (or driving force calculation circuitry 127) calculates a target driving force to be generated by the powertrain devices (the engine 10 and the transmission 20). To achieve the target motion, the braking force calculation unit 128 (or braking force calculation circuitry 128) calculates a target braking force to be generated by the brake device 30. To achieve the target motion, the steering amount calculation unit 129 (or steering amount calculation circuitry 129) calculates a target steering amount to be generated by the steering device 40.

Here, in the configuration of FIG. 7, the driving force calculation unit 127, the braking force calculation unit 128, and the steering amount calculation unit 129 can communicate with one another. In addition, the driving force calculation unit 127, the braking force calculation unit 128, and the steering amount calculation unit 129 share information related to the physical amounts calculated by these units with one another, and are configured to be capable of calculating associated target physical amounts so as to be capable of executing control to allow the traveling devices to cooperate with one another.

Thus, for example, while a road surface is slippery, the need arises to reduce the rotation of the wheels (to perform so-called traction control) to prevent the wheels from spinning. To reduce spinning of the wheels, the output of the powertrain may be reduced, or the braking force of the brake device 30 may be used. However, if the driving force calculation unit 127 and the braking force calculation unit 128 respectively set the driving force to be generated by the powertrain and the braking force to be generated by the brake device 30 to associated optimum values, the running performance of the vehicle can be stabilized.

When the vehicle 1 is to corner, the driving force calculation unit 127 calculates a target driving force based on the driving state of the vehicle (the driving state determined by the vehicle motion determination unit 116), calculates the amount of the driving force reduced in response to the target steering amount calculated by the steering amount calculation unit 129, and then calculates a final target driving force of the vehicle in response to the target driving force and the amount of the driving force reduced. This allows a deceleration corresponding to the target steering amount to be produced. As a result, rolling and pitching that causes a front portion of the vehicle 1 to move downward are induced in synchronization with each other to give rise to diagonal rolling. Giving rise to the diagonal rolling increases the load applied to the outer front wheel 50. This allows the vehicle to corner with small steering angle, and can reduce the rolling resistance to the vehicle 1.

<Output Destination of Arithmetic Unit>

An arithmetic result of the arithmetic unit 110 is output to the powertrain ECU 210, the brake microcomputer 310, the EPAS microcomputer 410, and a body-related microcomputer 600. Specifically, information related to the target driving force calculated by the driving force calculation unit 127 is input to the powertrain ECU 210. Information related to the target braking force calculated by the braking force calculation unit 128 is input to the brake microcomputer 310. Information related to the target steering amount calculated by the steering amount calculation unit 129 is input to the EPAS microcomputer 410. Information related to the operations of the body-related devices set by the peripheral device operation setting unit 140 is input to the body-related microcomputer 600. Here, in the present embodiment, the driving force calculation unit 127, the braking force calculation unit 128, and the steering amount calculation unit 129 share information related to the physical amounts calculated by these units with one another, and are configured to be capable of executing control to allow the traveling devices to cooperate with one another. Thus, in the present embodiment, the powertrain ECU 210, the brake microcomputer 310, and the EPAS microcomputer 410 merely need to calculate actual controlled variables based on the outputs from the driving force calculation unit 127, the braking force calculation unit 128, and the steering amount calculation unit 129, respectively, and to output the resultant control signals to the traveling devices (e.g., the injector 12). This can reduce the sizes of the device controllers 210 to 410.

Also in the present embodiment, the operation input information on the driver's operations output from the driving operation information acquisition device SW0 is input to both the arithmetic unit 110 and a control unit 800. The control unit 800 includes the powertrain ECU 210, the brake microcomputer 310, and the EPAS microcomputer 410.

Thus, just like the first embodiment, the arithmetic unit 110 can be configured to reflect an input from the driving operation information acquisition device SW0 in the route that is to be determined by the route determination unit 115, for example. Control may be performed such that the driver's intention is reflected in the outputs from the arithmetic unit 110.

Furthermore, an output from the driving operation information acquisition device SW0 is input also to the control unit 800. Thus, this output can be used for verification, correction, or any other process of the arithmetic result obtained by the arithmetic unit 110.

As can be seen from the foregoing description, also in the present embodiment, just like the first embodiment, control that reflects the driver's intention without impairing the driver' s comfort can be achieved even if the motor vehicle intervenes in driving (e.g., in the case of adopting autonomous driving).

<Other Control Manners>

The driving force calculation unit 117, the braking force calculation unit 118, and the steering amount calculation unit 119 may be configured to modify the target driving force and other associated elements in accordance with the status of the driver of the vehicle 1, during the assist driving of the vehicle 1. For example, when the driver enjoys driving (when the driver feels “happy”), the target driving force and other associated elements may be reduced to make driving as close as possible to manual driving. On the other hand, when the driver is not feeling well, the target driving force and other associated elements may be increased to make the driving as close as possible to the autonomous driving.

(Other Embodiments)

The present disclosure is not limited to the embodiments described above, and may be modified within the scope of the claims.

For example, in the above-described embodiments, the route determination unit 115 determines the route to be travelled by the vehicle 1. However, the present disclosure is not limited to this, and the route determination unit 115 may be omitted. In this case, the vehicle motion determination unit 116 may determine the route to be traveled by the vehicle 1. That is, the vehicle motion determination unit 116 may serve as a part of the route setting unit as well as a target motion determination unit.

In addition, in the above-described embodiments, the driving force calculation unit 117, the braking force calculation unit 118, and the steering amount calculation unit 119 calculate target physical amounts such as a target driving force. However, the present disclosure is not limited to this. The driving force calculation unit 117, the braking force calculation unit 118, and the steering amount calculation unit 119 may be omitted, and the target physical amounts may be calculated by the vehicle motion determination unit 116. That is, the vehicle motion determination unit 116 may serve as the target motion determination unit as well as a physical amount calculation unit.

The embodiments described above are merely examples in nature, and the scope of present disclosure should not be interpreted in a limited manner. The scope of the present disclosure is defined by the appended claims, and all variations and modifications belonging to a range equivalent to the range of the claims are within the scope of the present disclosure.

### INDUSTRIAL APPLICABILITY

The present disclosure is usable as a vehicle cruise control system to control traveling of the vehicle.

### DESCRIPTION OF REFERENCE CHARACTERS

1 Vehicle

100 Vehicle Cruise Control System

110 Arithmetic Unit

200 Powertrain ECU 200 (Device Controller)

300 Brake Microcomputer (Device Controller)

400 DSC Microcomputer (Device Controller)

1. A motor vehicle cruise control system for controlling traveling of a motor vehicle, comprising:
arithmetic circuitry configured to generate a route that avoids an obstacle on a road, based on an output from a vehicle exterior information acquisition device, determine a target motion of the motor vehicle during traveling of the motor vehicle along the route, and calculate a target physical momentum of a traveling device for achieving the target motion, the vehicle exterior information acquisition device being configured to acquire information on an environment outside of the motor vehicle; and
device control circuitry configured to generate an actuation control signal for controlling an actuation of the traveling device mounted in the motor vehicle, based on an arithmetic result obtained by the arithmetic circuitry, and output the actuation control signal to the traveling device,
driving operation information on an operation performed by a driver being input to both the arithmetic circuitry and the device control circuitry in parallel,
the arithmetic circuitry being configured to reflect the driving operation information in a process of determining the target motion,
the device control circuitry being configured to reflect the driving operation information in the control of the actuation of the traveling device.

2. The motor vehicle cruise control system of claim 1, wherein
the device control circuitry generates a manual driving signal for controlling the actuation of the traveling device, based on the driving operation information on the operation performed by the driver, and outputs the manual driving signal, instead of the actuation control signal, to the traveling device if a predetermined condition determined in advance is satisfied.

3. The motor vehicle cruise control system of claim 1, wherein
the device control circuitry generates manual driving information for controlling the actuation of the traveling device, based on the driving operation information on the operation performed by the driver, and corrects the actuation control signal based on the driving operation information if a behavior of the traveling device based on the actuation control signal deviates from a motion based on the manual driving information by an amount greater than or equal to a predetermined reference.

4. The motor vehicle cruise control system of claim 1, wherein
the device control circuitry generates a manual driving signal for controlling the actuation of the traveling device, based on the driving operation information on the operation performed by the driver.

5. The motor vehicle cruise control system of claim 1, wherein the vehicle exterior information acquisition device includes a camera and a radar device.

6. The motor vehicle cruise control system of claim 2, wherein the vehicle exterior information acquisition device includes a camera and a radar device.

7. The motor vehicle cruise control system of claim 3, wherein the vehicle exterior information acquisition device includes a camera and a radar device.

8. The motor vehicle cruise control system of claim 4, wherein the vehicle exterior information acquisition device includes a camera and a radar device.

9. A vehicle cruise control method that controls traveling of a vehicle, the vehicle cruise control method comprising:
generating, by arithmetic circuitry, a route that avoids an obstacle on a road, based on an output from a vehicle exterior information acquisition device;
determining, by the arithmetic circuitry, a target motion of the motor vehicle during traveling of the motor vehicle along the route;
calculating, by the arithmetic circuitry, a target physical momentum of a traveling device for achieving the target motion, the vehicle exterior information acquisition device being configured to acquire information on an environment outside of the motor vehicle; and
generating, by device control circuitry, an actuation control signal for controlling an actuation of the traveling device mounted in the motor vehicle, based on an arithmetic result obtained by the arithmetic circuitry, and outputting the actuation control signal to the traveling device,
inputting to both the arithmetic circuitry and the device control circuitry in parallel, driving operation information on an operation performed by a driver;
reflecting, by the arithmetic circuitry, the driving operation information in a process of determining the target motion; and
reflecting, by the device control circuitry, the driving operation information in the control of the actuation of the traveling device.

10. The vehicle cruise control method of claim 9, comprising:
generating, by the device control circuitry, a manual driving signal for controlling the actuation of the traveling device, based on the driving operation information on the operation performed by the driver, and outputting the manual driving signal, instead of the actuation control signal, to the traveling device if a predetermined condition determined in advance is satisfied.

11. The vehicle cruise control method of claim 9, comprising:
generating, by the device control circuitry, manual driving information for controlling the actuation of the traveling device, based on the driving operation information on the operation performed by the driver, and correcting the actuation control signal based on the driving operation information if a behavior of the traveling device based on the actuation control signal deviates from a motion based on the manual driving information by an amount greater than or equal to a predetermined reference.

12. The vehicle cruise control method of claim 9, comprising:
generating, by the device control circuitry, a manual driving signal for controlling the actuation of the traveling device, based on the driving operation information on the operation performed by the driver.

13. The vehicle cruise control method of claim 9, wherein the vehicle exterior information acquisition device includes a camera and a radar device.

14. The vehicle cruise control method of claim 10, wherein the vehicle exterior information acquisition device includes a camera and a radar device.

15. The vehicle cruise control method of claim 11, wherein the vehicle exterior information acquisition device includes a camera and a radar device.

16. The vehicle cruise control method of claim 12, wherein the vehicle exterior information acquisition device includes a camera and a radar device.
